(19) United States
(12) Patent Application Publication
(10) Pub. No.: US 2012/0113050 A1
(43) Pub. Date: May 10, 2012

(54) TOUCH DISPLAY PANEL

(75) Inventors: Wen-Chun Wang, Taichung City (TW); Chin-Chang Liu, Taichung County (TW); Kuo-Chang Su, Tainan County (TW); Hen-Ta Kang, Taichung City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/287,113

(22) Filed: Nov. 1, 2011

(30) Foreign Application Priority Data
Nov. 9, 2010 (TW) 99138540

(51) Int. Cl. G06F 3/045

(52) U.S. Cl. 345/174

(57) ABSTRACT

A touch display panel is disclosed, which includes a first substrate, a second substrate, a touch sensing structure disposed on the first substrate, an organic light emitting diode (OLED) pixel array, and a sealant sealing the OLED pixel array between the first substrate and the second substrate. The OLED pixel array includes a plurality of OLED pixel units and an isolation structure isolating the adjacent OLED pixel units from each other. Each of the OLED pixel units includes a first electrode, an organic light emitting layer, a second electrode, an active device, and a conductive component electrically connecting the active device to the first electrode. The first electrodes, the organic light emitting layers, and the second electrodes are sequentially disposed on the first substrate, and the active devices are disposed on the second substrate.

### CROSS-REFERENCE TO RELATED APPLICATION

This application claims the priority benefit of Taiwan application serial no. 99138540, filed on Nov. 9, 2010. The entirety of the above-mentioned patent application is hereby incorporated by reference herein and made a part of this specification.

### BACKGROUND OF THE INVENTION

1. Field of the Invention

The invention generally relates to a touch display panel, and more particularly, to a touch display panel using an organic light emitting layer to perform displaying.

2. Description of Related Art

In recent years, the information technology, the wireless mobile communication, and the information household appliances have been rapidly developed in various applications. In order to achieve the objective of features with more-convenient usage, more-compact volume, and more-human friendly design, the inputting device in many information products has been changed from the traditional keyboard or mouse to a touch display panel already. Among the general designs of touch display panels currently, in terms of the design principle of touch sensing mode, it is roughly categorized into restive type, capacitive type, optical type, acoustic type, and electromagnetic type, wherein the restive type and the capacitive type have played a major role in the touch display panel market.

A conventional touch display panel today is manufactured by respectively fabricating the touch panel and the display panel thereof, and assembling up the above-mentioned touch panel with the display panel. The above-mentioned process method for manufacturing the touch display panel has disadvantages of higher cost, more heavy, and lower optical transmittance, which need to be overcome.

### SUMMARY OF THE INVENTION

Accordingly, the invention is directed to a touch display panel, wherein an organic light emitting layer provides displaying function, and a touch sensing structure and a display pixel array are integrated between two substrates so that the volume of the touch display panel is decreased.

The invention provides a touch display panel, which includes a first substrate, a second substrate, a touch sensing structure, an organic light emitting diode (OLED) pixel array, and a sealant. The first substrate is opposite to the second substrate. The touch sensing structure is disposed on the first substrate and located between the first substrate and the second substrate. The sealant is disposed between the first substrate and the second substrate and seals the OLED pixel array between the first substrate and the second substrate. The OLED pixel array includes a plurality of OLED pixel units and an isolation structure. Each of the OLED pixel units includes a first electrode, an organic light emitting layer, a second electrode, an active device, and a conductive component. The first electrode, the organic light emitting layer, and the second electrode are sequentially disposed on the first substrate, and the isolation structure isolates at least the organic light emitting layers of adjacent OLED pixel units from each other. The active device is disposed on the second substrate. The conductive component connects the active device to the first electrode.

Based on the depiction above, the invention takes a design that the touch sensing structure is disposed on the substrate where the OLED pixel arrays are packaged so as to constitute a touch display panel. In this way, no extra substrate is used except the two substrates sealing the OLED pixel array, which is helpful to reduce the thickness of the touch display panel.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional diagram of a touch display panel according to a first embodiment of the invention.

FIG. 1B is a top-view diagram showing the first substrate and the second substrate in the touch display panel of FIG. 1A.

FIG. 2 is a cross-sectional diagram of a touch display panel according to a second embodiment of the invention.

FIG. 3 is a cross-sectional diagram of a touch display panel according to a third embodiment of the invention.

FIG. 4 is a cross-sectional diagram of a touch display panel according to a fourth embodiment of the invention.

FIG. 5 is a cross-sectional diagram of a touch display panel according to a fifth embodiment of the invention.

FIG. 6 is a cross-sectional diagram of a touch display panel according to a sixth embodiment of the invention.

### DESCRIPTION OF THE EMBODIMENTS

Reference will now be made in detail to the preferred embodiments of the invention, examples of which are illustrated in the accompanying drawings. Wherever possible, the same reference numbers are used in the drawings and the description to refer to the same or like parts.

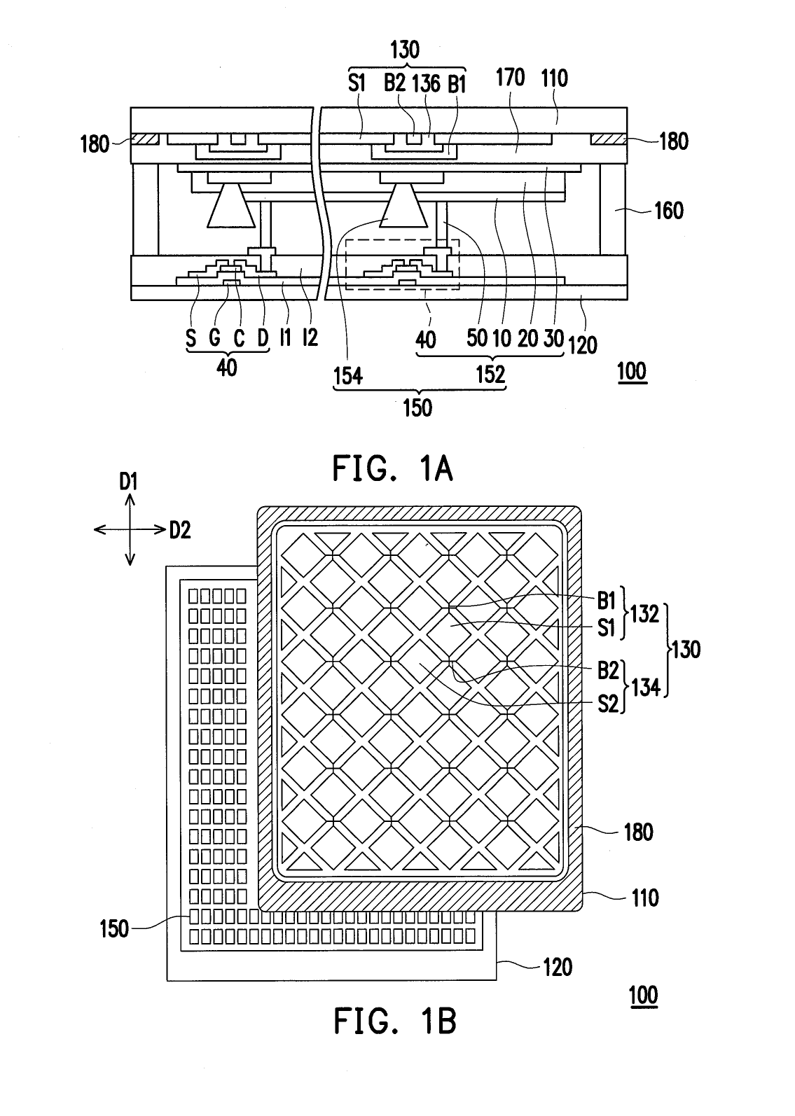

FIG. 1A is a cross-sectional diagram of a touch display panel according to a first embodiment of the invention and FIG. 1B is a top-view diagram showing the first substrate and the second substrate in the touch display panel of FIG. 1A. Referring to FIGS. 1A and 1B, a touch display panel 100 includes a first substrate 110, a second substrate 120, a touch sensing structure 130, an OLED pixel array 150, and a sealant 160. The first substrate 110 is opposite to the second substrate 120. The touch sensing structure 130 is disposed on the first substrate 110 and located between the first substrate 110 and the second substrate 120. The OLED pixel array 150 is located between the touch sensing structure 130 and the second substrate 120. The sealant 160 is disposed between the first substrate 110 and the second substrate 120 and seals the OLED pixel array 150 between the first substrate 110 and the second substrate 120. In the embodiment, the touch display panel 100 can also include a protection layer 170 and a decoration layer 180. The protection layer 170 is disposed at a side of the touch sensing structure 130 far away from the first substrate 110. By disposing the protection layer 170, the touch sensing structure 130 can be protected to ensure the touch sensing operation can be normally conducted. In addition, the decoration layer 180 is disposed on the first substrate 110. The material of the decoration layer 180 includes ink, diamond-like-carbon (DLC), and the like, and the decoration layer 180 can form specific marks or light-shielding patterns to beautify the appearance of the touch display panel 100 and further shield the circuit layout.

It should be noted that the OLED pixel array 150 includes a plurality of OLED pixel units 152 and an isolation structure 154. Each of the OLED pixel units 152 includes a first electrode 10, an organic light emitting layer 20, a second electrode 30, an active device 40, and a conductive component 50. Usually, the active device 40 can include a gate G, a channel layer C, a source S, and a drain D, and an insulation layer I1 can be disposed between the gate G and the channel layer C while another insulation layer I2 can cover the source S and the drain D.

In the embodiment, the first electrode 10, the organic light emitting layer 20, and the second electrode 30 are sequentially disposed on the first substrate 110, and the isolation structure 154 isolates at least the organic light emitting layers 20 of the adjacent OLED pixel units 152 from each other. In addition, the active device 40 is disposed on the second substrate 120 and the conductive component 50 is disposed between the active device 40 and the first electrode 10 so as to electrically connect the active device 40 to the first electrode 10. It should be noted that so-called ‘sequentially disposed’ in the embodiment is not limited to ‘sequentially disposed from the first substrate 110 to the second substrate 120’ or ‘sequentially disposed from the second substrate 120 to the first substrate 110’. Hence, the disposing sequence shown by FIG. 1 is an example for explanation, not to limit that the first electrode 10 must be closer to the second substrate 120.

The stacked structure of the first electrode 10, the organic light emitting layer 20, and the second electrode 30 and the active device 40 are respectively disposed on the first substrate 110 and the second substrate 120, so that the stacked structure of the first electrode 10, the organic light emitting layer 20, and the second electrode 30 is opposite to the active device 40 in the embodiment; and furthermore, a conductive component 50 is needed to electrically connect the first electrode 10 to the active device 40. In the embodiment, the organic light emitting layer 20 and the active device 40 are fabricated respectively on the different substrates (110 and 120), which can reduce the mutual influence between the production yield of the organic light emitting layer 20 and the production yield of the active device 40.

For example, if the organic light emitting layer 20 and the active device 40 are fabricated on a same substrate, when the production yield of the active device 40 is significantly higher than the production yield of the organic light emitting layer 20, it is possible that a poor organic light emitting layer 20 is disposed on a good active device 40. As a result, the whole substrate disposed by such device must be discarded, the good active device 40 can not be utilized and the fabrication cost is increased. In order to avoid the above-mentioned problem, in the embodiment, the structure stacked by the first electrode 10, the organic light emitting layer 20, and the second electrode 30 and the active device 40 are respectively disposed on the first substrate 110 and the second substrate 120, which is helpful to keep good production yield and avoid unnecessary cost.

The touch sensing structure 130 includes a plurality of first sensing series 132 and a plurality of second sensing series 134. The first sensing series 132 are, for example, electrically insulated from the second sensing series 134, and a first extension direction D1 of each first sensing series 132 is different from a second extension direction D2 of each second sensing series 134. Each of the first sensing series 132 includes a plurality of first sensing pads S1 and a plurality of first conductive lines B1, wherein the first conductive lines B1 connect in series the first sensing pads S1 along the first extension direction D1. Each of the second sensing series 134 includes a plurality of second sensing pads S2 and a plurality of second conductive lines B2, wherein the second conductive lines B2 connect in series the second sensing pads S2 along the second extension direction D2. In order to keep the electrical performance of each component, the touch sensing structure 130 further includes an insulation pattern 136 disposed between the first conductive lines B1 and the second conductive lines B2. It can be seen from FIG. 1A, the first conductive lines B1 are, for example, cross over the insulation pattern 136 to connect in series the adjacent first sensing pads S1.

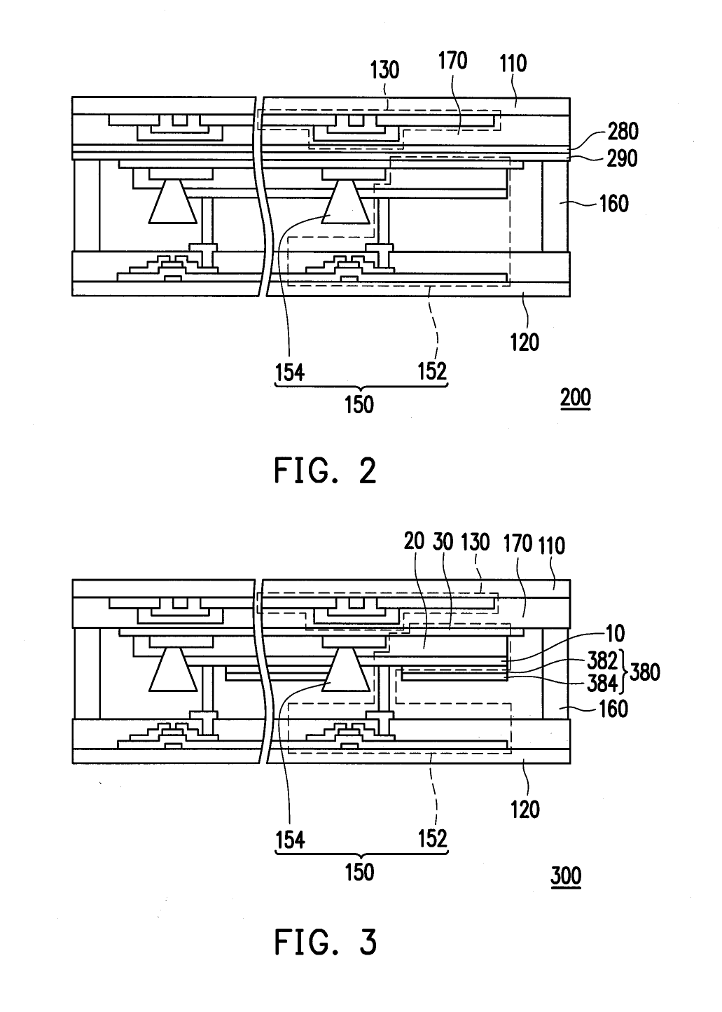

FIG. 2 is a cross-sectional diagram of a touch display panel according to a second embodiment of the invention. Referring to FIG. 2, a touch display panel 200 is another implementation of the invention that in addition to the components of the touch display panel 100, a shielding layer 280 and an insulation layer 290 are further disposed. The relationships between the components of the touch display panel 200 can be referred to the depiction of the first embodiment except the shielding layer 280 and the insulation layer 290. In the embodiment, the insulation layer 290 is disposed, for example, between the touch sensing structure 130 and the OLED pixel units 152, and the shielding layer 280 is disposed between the insulation layer 290 and the touch sensing structure 130. The shielding layer 280 is able to reduce the probability of the signal interference between the OLED pixel units 152 and the touch sensing structure 130, so as to obtain more ideal touch sensing precision and better displaying effect.

FIG. 3 is a cross-sectional diagram of a touch display panel according to a third embodiment of the invention. Referring to FIG. 3, a touch display panel 300 is substantially the same as the touch display panel 100 except that the touch display panel 300 further includes an isolation layer 380. The isolation layer 380 can include a stacked moisture-absorbing layer 382 and a protection layer 384. The isolation layer 380 is disposed on the first substrate 110, and the first electrodes 10, the organic light emitting layers 20, and the second electrodes 30 of the OLED pixel units 152 are sandwiched by the touch sensing structure 130 and the isolation layer 380. In this way, the isolation layer 380 is able to effectively avoid moisture from entering into the organic light emitting layers 20 so as to make the organic light emitting layers 20 effectively emit light and thereby advance the reliability of the touch display panel 300.

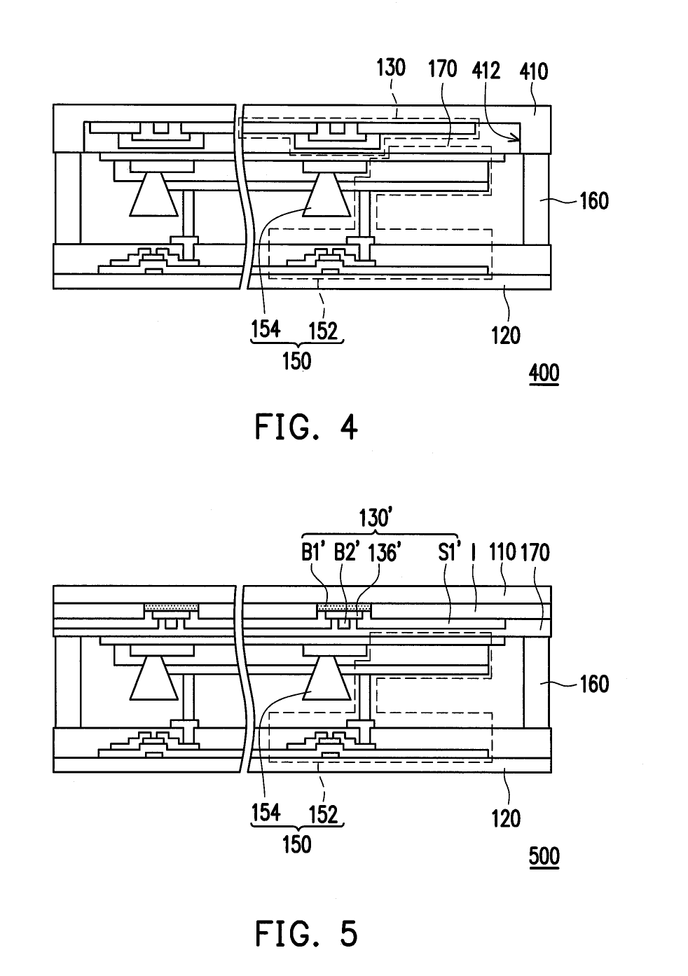

FIG. 4 is a cross-sectional diagram of a touch display panel according to a fourth embodiment of the invention. Referring to FIG. 4, a touch display panel 400 is roughly the same as the above-mentioned touch display panel 100 except for the first substrate 410. In the embodiment, the first substrate 410 has a cavity 412 and the touch sensing structure 130 is disposed in the cavity 412. In this way, the thickness of the protection layer 170 between the touch sensing structure 130 and the OLED pixel units 152 can be increased so as to avoid the mutual electrical interference thereof.

FIG. 5 is a cross-sectional diagram of a touch display panel according to a fifth embodiment of the invention. Referring to FIG. 5, a touch display panel 500 is substantially similar to the above-mentioned touch display panel 100 except the design of the touch sensing structure 130′. In the embodiment, the top-view of the touch sensing structure 130′ is shown by FIG. 1B, where the touch sensing structure 130′ comprises a plurality of first sensing series 132 and a plurality of second sensing series 134. In more details, the touch sensing structure 130′ of the embodiment has a different cross-sectional structure from the touch sensing structure 130 of the first embodiment. In the embodiment, the first conductive lines B1′ are the parts of the touch sensing structure 130′ most close to the first substrate 110, while the insulation pattern 136′ is disposed, for example, on the first conductive lines B1′ to isolate the first conductive lines B1′ from the second conductive lines B2′. In addition, the first sensing pads S1′ can be disposed on an insulation layer I, wherein the insulation layer I and the insulation pattern 136 can be a same film layer.

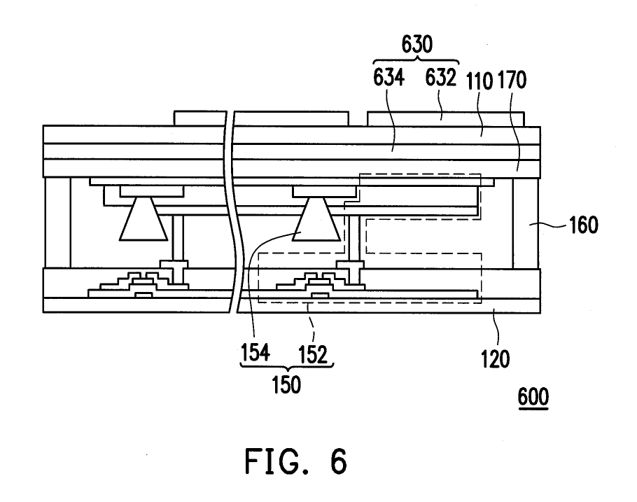

FIG. 6 is a cross-sectional diagram of a touch display panel according to a sixth embodiment of the invention. Referring to FIG. 6, a touch display panel 600 includes a first substrate 110, a second substrate 120, a touch sensing structure 630, an OLED pixel array 150, and a sealant 160, wherein the relationships between the first substrate 110, the second substrate 120, the OLED pixel array 150, and the sealant 160 can be referred to the depiction of the first embodiment. In more details, the difference of the embodiment from the first embodiment rests in the design of the touch sensing structure 630. In the embodiment, the touch sensing structure 630 comprises a plurality of first bar-like electrodes 632 and a plurality of second bar-like electrodes 634, wherein each of the first bar-like electrodes 632 and each of the second bar-like electrodes 634 respectively extend along different directions. In addition, the first bar-like electrodes 632 and the second bar-like electrodes 634 are respectively disposed at two opposite sides of the first substrate 110. Besides, although in the second to the sixth embodiments, no decoration layer is shown in the corresponding figures, the invention allows a decoration layer 180 is employed and disposed in the touch display panels 200, 300, 400, 500 and 600 respectively corresponding to the second to the sixth embodiments. The decoration layer 180 is conducive to shield the circuit layout.

In summary, in the invention, the touch sensing structure is disposed on the substrate used to package the OLED pixel array. Hence, the touch display panel does not need an extra substrate to have the touch sensing function and the displaying function, which is helpful to reduce the thickness of the touch display panel. In addition, in the invention, the organic light emitting layers and the active devices are fabricated on different substrates, which can advance the production yield of the touch display panel. Moreover, in the invention, a cavity is formed on the substrate to make the touch sensing structure disposed in the cavity, which contributes to reduce the electrical interference between the touch sensing structure and the OLED pixel units.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A touch display panel, comprising:
a first substrate;
a second substrate, opposite to the first substrate;
a touch sensing structure, disposed on the first substrate and located between the first substrate and the second substrate;
an organic light emitting diode pixel array, comprising a plurality of organic light emitting diode pixel units and an isolation structure, wherein each of the organic light emitting diode pixel units comprises:
a first electrode;
an organic light emitting layer;
a second electrode, wherein the first electrode, the organic light emitting layer, and the second electrode are sequentially disposed on the first substrate, and the isolation structure isolates at least the organic light emitting layers of adjacent organic light emitting diode pixel units from each other;
an active device, disposed on the second substrate;
a conductive component, connecting the active device to the first electrode; and
a sealant, disposed between the first substrate and the second substrate and sealing the organic light emitting diode pixel array between the first substrate and the second substrate.

2. The touch display panel as claimed in claim 1, wherein the touch sensing structure comprises:
a plurality of first sensing series;
a plurality of second sensing series, electrically insulated from the first sensing series, wherein a first extension direction of each the first sensing series is different from a second extension direction of each the second sensing series; and
a protection layer, disposed at a side of the first sensing series and the second sensing series, wherein the side is far away from the first substrate.

3. The touch display panel as claimed in claim 2, wherein each of the first sensing series comprises a plurality of first sensing pads and a plurality of first conductive lines serially connecting the first sensing pads along the first extension direction, each of the second sensing series comprises a plurality of second sensing pads and a plurality of second conductive lines serially connecting the second sensing pads along the second extension direction, the touch display panel further comprises a plurality of insulation patterns disposed between the first conductive lines and the second conductive lines.

4. The touch display panel as claimed in claim 3, wherein the first conductive lines are located between the insulation patterns and the first substrate.

5. The touch display panel as claimed in claim 2, wherein each of the first sensing series comprises a first bar-like electrode and each of the second sensing series comprises a second bar-like electrode.

6. The touch display panel as claimed in claim 2, wherein the first sensing series and the second sensing series are located respectively at the two opposite sides of the first substrate.

7. The touch display panel as claimed in claim 1, further comprises a shielding layer and an insulation layer, wherein the insulation layer is disposed between the touch sensing structure and the organic light emitting diode pixel units, and the shielding layer is disposed between the insulation layer and the touch sensing structure.

8. The touch display panel as claimed in claim 1, further comprising an isolation layer disposed on the first substrate, wherein the first electrode, the organic light emitting layer, and the second electrode are sandwiched by the touch sensing structure and the isolation layer, the isolation layer comprises a moisture-absorbing layer and a protection layer, and the moisture-absorbing layer is located between the protection layer and the first substrate.

9. The touch display panel as claimed in claim 1, wherein the first substrate has a cavity and the touch sensing structure is located in the cavity.

10. The touch display panel as claimed in claim 1, further comprising a decoration layer disposed on the first substrate.
